(19) United States
(12) Patent Application Publication
(10) Pub. No.: US 2023/0011125 A1
(43) Pub. Date: Jan. 12, 2023

(54) FASTENING ELEMENT

(71) Applicant: Hilti Aktiengesellschaft, Schaan (LI)

(72) Inventors: Dennis YANG, Shanghai (CN); Xinyu SHU, Shanghai (CN); Mathias GOLDT, Shanghai (CN); Rachel YANG, Shanghai (CN)

(21) Appl. No.: 17/785,174

(22) PCT Filed: Jan. 20, 2021
(86) PCT No.: PCT/EP2021/051134

§ 371 Date: Jun. 14, 2022

(30) Foreign Application Priority Data
Jan. 21, 2020 (CN) 202010069299.1

(51) Int. Cl. F16B 1/02; B25C 1/18

(52) U.S. Cl. CPC F16B 1/02; B25C 1/188

(57) ABSTRACT

A fastening element (10) for attaching a component to a support structure in a fastening direction (20), comprising a receptacle (30) receiving a tool nose (110) of a setting tool and having an abutment face (40) and a trap element (50), the abutment face (40) facing against the fastening direction (20) and abutting a front face (130) of the tool nose (110) when the tool nose (110) is received in the receptacle (30), the trap element (50) locking the tool nose (110) in the receptacle (30) in the fastening direction (20), and a slide-in channel (60) allowing sliding the tool nose (110) into the receptacle (30) and having one or more guide elements (70) guiding the tool nose (110) in a sliding direction (80) when the tool nose (110) is slid into the receptacle (30), wherein the sliding direction (80) is oblique to the fastening direction (20).

### TECHNICAL FIELD

The present invention relates to a fastening element for attaching a component to a support structure.

### BACKGROUND ART

Fastening elements are known which are used for attaching components, such as rails or hangers, to a support structure, such as a wall or a ceiling. It is well known to temporarily attach such a fastening element to a tool nose of a setting tool and then fastening the fastening element to the support structure using the setting tool.

### SUMMARY OF INVENTION

According to a first aspect of the invention, a fastening element for attaching a component to a support structure in a fastening direction comprises a receptacle and a slide-in channel. The receptacle is provided for receiving a tool nose of a setting tool and has an abutment face and a trap element, the abutment face facing against the fastening direction and abutting a front face of the tool nose when the tool nose is received in the receptacle, and the trap element locking the tool nose in the receptacle in the fastening direction. The slide-in channel allows for sliding the tool nose into the receptacle and has one or more guide elements guiding the tool nose in a sliding direction when the tool nose is slid into the receptacle, wherein the sliding direction is oblique to the fastening direction. According to a preferred embodiment, the sliding direction is perpendicular to the fastening direction.

According to an embodiment, the trap element comprises a locking face facing in the fastening direction and engaging behind the tool nose when the tool nose is received in the receptacle.

According to a further embodiment, the fastening element further comprises a latch protruding in the slide-in channel and holding the tool nose in the sliding direction when the tool nose is received in the receptacle. According to a preferred embodiment, the latch is spring biased into the slide-in channel and is pushed out of the slide-in channel by the tool nose when the tool nose is slid into the receptacle. According to another preferred embodiment, the latch comprises a first chamfer on its side facing against the sliding direction. According to another preferred embodiment, the latch comprises a second chamfer on its side facing in the sliding direction. According to another preferred embodiment, the trap element comprises the latch.

According to a further embodiment, the trap element is spring biased against the tool nose when the tool nose is received in the receptacle. According to a preferred embodiment, a spring force biasing the trap element against the tool nose corresponds to a minimum pull-out force to be provided to the fastening element against the support structure.

### BRIEF DESCRIPTION OF DRAWINGS

The invention will be described in more detail by way of example hereinafter with reference to the drawings. The described embodiments are only possible configurations in which the individual features may however be implemented independently of each other or may be omitted.

In the drawings:

FIG. 1 is a perspective view of a fastening element according to a first embodiment of the present invention;

FIG. 2 is a side view of the fastening element shown in FIG. 1;

FIG. 3 is a top view of the fastening element shown in FIG. 1 ;

FIG. 4 is a cross-sectional view of the fastening element shown in FIG. 3 along a face A-A;

FIG. 5 is a perspective view of a tool nose and the fastening element shown in FIG. 1 before sliding onto the tool nose;

FIG. 6 is a perspective view of the tool nose shown in FIG. 5 and the fastening element shown in FIG. 1 during sliding onto the tool nose;

FIG. 7 is a perspective view of the tool nose shown in FIG. 5 and the fastening element shown in FIG. 1 after sliding onto the tool nose;

FIG. 8 is a side view of the tool nose shown in FIG. 5 and the fastening element shown in FIG. 1 after fastening to a support structure;

FIG. 9 is a perspective view of a fastening element according to a second embodiment of the present invention;

FIG. 10 is a side view of the fastening element shown in FIG. 9; and

FIG. 11 is another perspective view of the fastening element shown in FIG. 9.

### DESCRIPTION OF EMBODIMENTS

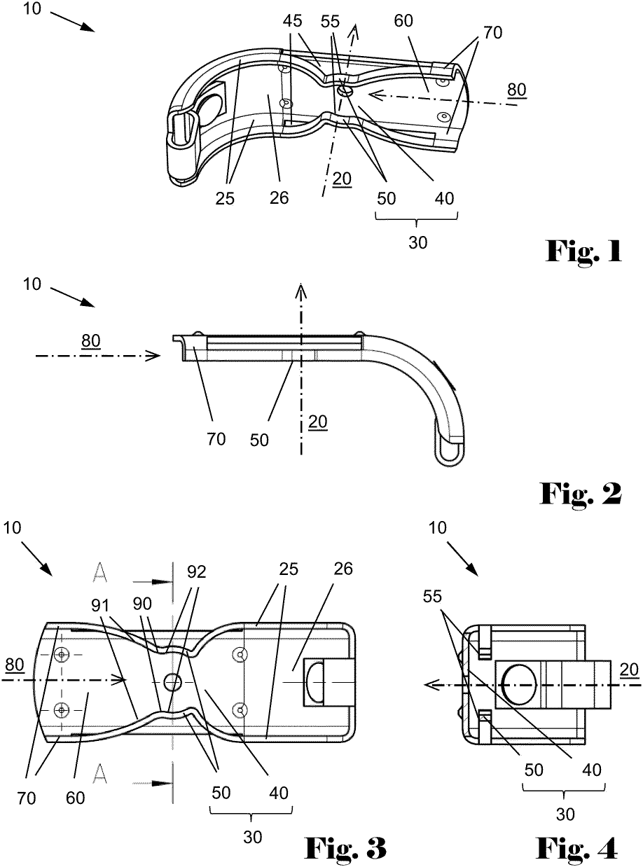

FIGS. 1-4 show a fastening element 10 for attaching a component (not shown) to a support structure (not shown) in a fastening direction 20. In the shown embodiment, the fastening element 10 is made of a base plate of sheet metal, for example iron or aluminium, or alloy, for example steel, extending in a plane which is perpendicular with respect to the fastening direction 20 and having two opposing lateral edges 25 bent by, for example, approximately 90°. A main face 26 facing against the fastening direction 20 is thereby formed between the two opposing lateral edges 25.

The fastening element 10 comprises a receptacle 30 provided for receiving a tool nose of a setting tool (not shown). To this end, the receptacle 30 has an abutment face 40 and a trap element 50. The abutment face 40 is a section of the main face 26, faces against the fastening direction 20, and is provided for abutting a front face of the tool nose when the tool nose is received in the receptacle 30, as described below. The trap element 50 is formed by the two opposing bent lateral edges 25 of the base plate described above, and is provided for locking the tool nose in the receptacle 30 in the fasten ing direction 20, as likewise described below. To this end, the trap element 50 comprises two locking faces 55 facing in the fastening direction 20 and engaging, with respect to the fastening direction 20, behind the tool nose when the tool nose is received in the receptacle 30. Further, the trap element 50 is spring biased against the tool nose when the tool nose is received in the receptacle 30. To this end, the fastening element 10 is provided with a particularly slit-shaped cut-out 45 between the trap element 50 and the abutment face 40. A spring force biasing the trap element 50 against the tool nose corresponds to a minimum pull-out force to be provided to the fastening element 10 against the support structure.

The fastening element 10 further comprises a slide-in channel 60 which allows for sliding the tool nose into the receptacle 30. To this end, the slide-in channel 60 has two guide elements 70 which are formed by the two opposing bent lateral edges 25 of the base plate described above, and are provided for guiding the tool nose in a sliding direction 80 when the tool nose is slid into the receptacle 30. The sliding direction 80 is perpendicular to the fastening direction 20. In non-shown embodiments, the sliding direction is oblique to the fastening direction, wherein an angle between the two directions is more than 0°, in particular more than 30° or more than 45°, and less than 90°.

The fastening element 10, in particular the trap element 50, further comprises two latches 90 protruding from two opposing lateral sides (from above and below in FIG. 3) in the slide-in channel 60 and holding the tool nose in the sliding direction 80 when the tool nose is received in the receptacle 30. The latches 90 are spring biased into the slide-in channel 60 and are pushed out of the slide-in channel 60 by the tool nose when the tool nose is slid into the receptacle 30. The latches 90 each comprise a first chamfer 91 on their sides facing against the sliding direction 80, and a second chamfer 92 on their sides facing in the sliding direction 80.

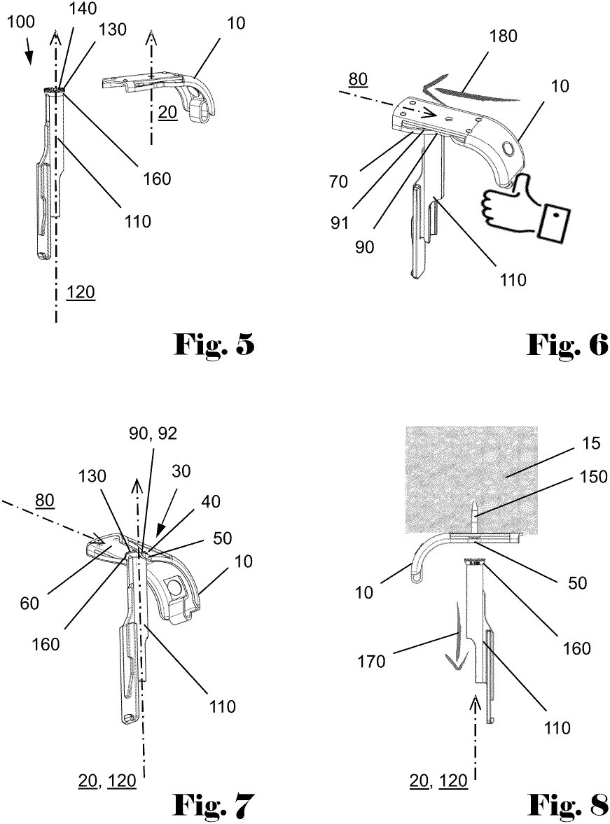

FIGS. 5-8 demonstrate a method of fastening the fastening element 10 shown in FIGS. 1-4 to a support structure 15, using a fastening tool 100, such as a nail gun. In non-shown embodiments, the fastening tool is a screw-driver or other fastening tool fitting to the application. The support structure 15 is shown in FIG. 8 and may be a construction element, such as a wall or ceiling, and may be made of concrete, metal or alloy, such as steel, timber or the like. The fastening tool 100 comprises a tool nose 110 which has, at a front face 130 of the tool nose 110 facing in a tool fastening direction 120, a mouth 140 for pushing fasteners 150 in the tool fastening direction. Slightly behind the front face 130, the tool nose 110 comprises a flare or shoulder 160. A fastener 150 formed as a nail is shown in FIG. 8. In non-shown embodiments, the fastener is formed as a stud, pin, screw, anchor, or the like, and may be chosen according to the application.

In a first step, as shown in FIG. 5, the fastening element 10 and the fastening tool 100 are provided and positioned such that the fastening direction 20 of the fastening element 10 and the tool fastening direction 120 are oriented parallel to each other.

In a further step, as shown in FIG. 6, the fastening element 10 is pushed in a direction 180 perpendicular to the fastening direction 20 and tool fastening direction 120 onto the tool nose 110 such that the tool nose 110 slides in the sliding direction 80 along the slide-in channel 60 into the receptacle 30 (both shown in FIGS. 1, 3). During sliding along the slide-in channel 60, the front face 130 of the tool nose 110 abuts the main face 26 (likewise shown in FIGS. 1, 3) and is guided in the slide-in channel 60 and in the sliding direction 80 by the guide elements 70. Also during sliding along the slide-in channel 60, the tool nose 110 abuts the first chamfers 91 and pushes the two latches 90 against their spring bias out of the slide-in channel 60 in order to free its way into the receptacle 30.

When the tool nose 110 is received in the receptacle 30, as shown in FIG. 7, the tool nose 110 is held, or trapped, between the abutment face 40 and the trap element 50. The abutment face 40 abuts the front face 130 of the tool nose 110. The locking faces 55 (shown in FIGS. 1, 4) abut and engage behind, with respect to the fastening direction 20, the shoulder 160 of the tool nose 110. The trap element 50 and the latches 90 are spring biased against the tool nose 110 and hold the tool nose 110 in the fastening direction 20 and in the sliding direction 80, respectively. To this end, the second chamfers 92 abut a lateral side of the tool nose 110.

In a further step, as shown in FIG. 8, a fastener 150 is driven in the fastening direction 20, or tool fastening direction 120, through the fastening element 10 into the support structure 15 by the fastening tool 100. To this end, the fastening element 10 may comprise an aperture through which the fastener 150 may be driven. Further, the support structure 15 may or may not be provided with a through hole or blind hole receiving the fastener 150. After driving the fastener 150 into the support structure 15, the tool nose 110 is pulled away from the receptacle 30 in a direction 170 opposite the fastening direction 20 and tool fastening direction 120 and against a spring force biasing the trap element 50 against the tool nose 110, either manually by a user of the fastening tool 100 or automatically by a recoil of the fastening tool 100 caused by the driving process. Thus, it is ensured that the fastening element 10 is secured on the support structure 15 at least with a minimum pull-out force corresponding to the spring force biasing the trap element 50 against the tool nose 110.

In a further step, a component (not shown) may be attached to the fastening element 10, thus being secured to the support structure 15.

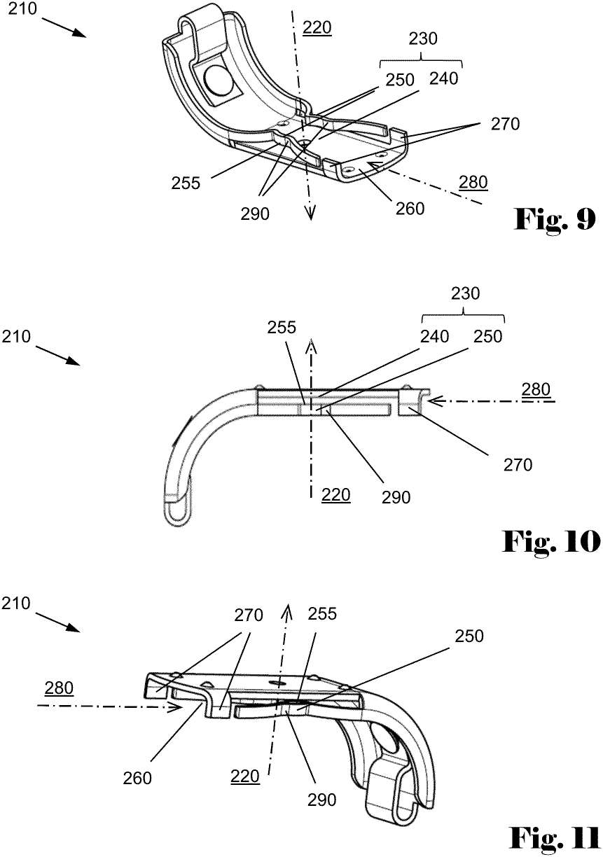

FIGS. 9-11 show a fastening element 210 for attaching a component (not shown) to a support structure (not shown) in a fastening direction 220. The fastening element 210 comprises a receptacle 230 provided for receiving a tool nose of a setting tool (not shown). To this end, the receptacle 230 has an abutment face 240 and a trap element 250. The abutment face 240 faces against the fastening direction 220 and is provided for abutting a front face of the tool nose when the tool nose is received in the receptacle 230. The trap element 250 is provided for locking the tool nose in the receptacle 230 in the fastening direction 220. To this end, the trap element 250 comprises two locking faces 255 facing in the fastening direction 220 and engaging, with respect to the fastening direction 220, behind the tool nose when the tool nose is received in the receptacle 230. Further, the trap element 250 is spring biased against the tool nose when the tool nose is received in the receptacle 230. To this end, the trap element 250 is formed as a leaf spring.

The fastening element 210 further comprises a slide-in channel 260 which allows for sliding the tool nose into the receptacle 230. To this end, the slide-in channel 260 has two guide elements 270 which are provided for guiding the tool nose in a sliding direction 280 when the tool nose is slid into the receptacle 230. The sliding direction 280 is perpendicular to the fastening direction 220. The fastening element 210, in particular the trap element 250, further comprises two latches 290 protruding from two opposing lateral sides in the slide-in channel 260 and holding the tool nose in the sliding direction 280 when the tool nose is received in the receptacle 230. The latches 290 are spring biased into the slide-in channel 260 by the leaf spring formed by the trap element 250, and are pushed out of the slide-in channel 260 by the tool nose when the tool nose is slid into the receptacle 230.

While the invention has been described with reference to its preferred embodiments, it will be understood by those skilled in the art that various changes may be made and equivalents may be substituted for elements thereof without departing from the true spirit and scope of the invention. All elements and features of the disclosed embodiments may be present individually or in any combination in all other embodiments, as long as not contradicting to each other. In addition, many modifications may be made to adapt a particular situation or material to the teaching of the invention without departing from its essential teachings.

1. A fastening element for attaching a component to a support structure in a fastening direction, comprising
a receptacle receiving a tool nose of a setting tool and having an abutment face and a trap element, the abutment face facing against the fastening direction and abutting a front face of the tool nose when the tool nose is received in the receptacle, the trap element locking the tool nose in the receptacle in the fastening direction, and
a slide-in channel allowing sliding the tool nose into the receptacle and having one or more guide elements guiding the tool nose in a sliding direction when the tool nose is slid into the receptacle, wherein the sliding direction is oblique to the fastening direction.

2. The fastening element according to claim 1, wherein the sliding direction is perpendicular to the fastening direction.

3. The fastening element according to claim 1, wherein the trap element comprises a locking face facing in the fastening direction and engaging behind the tool nose when the tool nose is received in the receptacle.

4. The fastening element according to claim 1, further comprising a latch protruding in the slide-in channel and holding the tool nose in the sliding direction when the tool nose is received in the receptacle.

5. The fastening element according to claim 4, wherein the latch is spring biased into the slide-in channel and is pushed out of the slide-in channel by the tool nose when the tool nose is slid into the receptacle.

6. The fastening element according to claim 4, wherein the latch comprises a first chamfer on its side facing against the sliding direction.

7. The fastening element according to claim 4, wherein the latch comprises a second chamfer on its side facing in the sliding direction.

8. The fastening element according to claim 4, wherein the trap element comprises the latch.

9. The fastening element according to claim 1, wherein the trap element is spring biased against the tool nose when the tool nose is received in the receptacle.

10. The fastening element according to claim 9, wherein a spring force biasing the trap element against the tool nose corresponds to a minimum pull-out force to be provided to the fastening element against the support structure.

11. The fastening element according to claim 2, wherein the trap element comprises a locking face facing in the fastening direction and engaging behind the tool nose when the tool nose is received in the receptacle.

12. The fastening element according to claim 2, further comprising a latch protruding in the slide-in channel and holding the tool nose in the sliding direction when the tool nose is received in the receptacle.

13. The fastening element according to claim 12, wherein the latch is spring biased into the slide-in channel and is pushed out of the slide-in channel by the tool nose when the tool nose is slid into the receptacle.

14. The fastening element according to claim 12, wherein the latch comprises a first chamfer on its side facing against the sliding direction.

15. The fastening element according to claim 12, wherein the latch comprises a second chamfer on its side facing in the sliding direction.

16. The fastening element according to claim 12, wherein the trap element comprises the latch.

17. The fastening element according to claim 2, wherein the trap element is spring biased against the tool nose when the tool nose is received in the receptacle.

18. The fastening element according to claim 17, wherein a spring force biasing the trap element against the tool nose corresponds to a minimum pull-out force to be provided to the fastening element against the support structure.
